(19) United States
(12) Patent Application Publication
(10) Pub. No.: US 2012/0155692 A1
(43) Pub. Date: Jun. 21, 2012

(54) WIRED EARPHONE

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/091,147

(22) Filed: Apr. 21, 2011

(30) Foreign Application Priority Data
Dec. 20, 2010 (CN) 201010596704.1

(51) Int. Cl. H04R 1/10

(52) U.S. Cl. 381/380

(57) ABSTRACT

An exemplary earphone includes a shell, a speaker received in the shell and a wire electrically connecting with the speaker. The shell defines a sound cavity therein. The speaker is received in the sound cavity. The shell further defines a wire passage therein. The wire passage communicates with the sound cavity. The wire is inserted into the sound cavity through the wire passage. The earphone further includes a sealing assembly coupled with the shell. The sealing assembly seals the wire passage from the outside environment.

### CROSS-REFERENCE TO RELATED APPLICATION

This application is related to a U.S. patent application entitled “WIRED EARPHONE,” filed on the same date as this application and having the same assignee as this application. The disclosure of the above-identified application is incorporated herein by reference.

### BACKGROUND

1. Technical Field

The present disclosure relates to earphones, and particularly to a wired earphone.

2. Description of Related Art

A typical earphone includes a shell, a speaker mounted in the shell, and a wire electrically connected with the speaker. The shell defines a sound cavity therein and a through hole communicating with the sound cavity. The speaker is located in the sound cavity. The wire is inserted into the sound cavity through the through hole. A diameter of the through hole is usually slightly larger than that of the wire, for facilitating the wire to extend through the through hole. The wire is thus loosely received in the through hole of the shell. A clearance is defined between the wire and an inner wall of the shell around the through hole. The through hole communicates with the external environment through the clearance. The existence of the clearance tends to reduce the sound quality of the earphone.

Furthermore, during using of the earphone, some external contaminants, such as dust or sweat, may infiltrate into the sound cavity of the shell through the clearance.

This can adversely affect the sound quality of the earphone, and may even cause damage to the speaker.

Accordingly, what is needed is an earphone which can overcome the limitations described.

### BRIEF DESCRIPTION OF THE DRAWINGS

FIG. 1 is an isometric, assembled view of an earphone in accordance with a first embodiment of the present disclosure.

FIG. 2 is an isometric, exploded view of the earphone of FIG. 1, showing another aspect thereof.

FIG. 3 is a bottom view of a back cover of a shell of the earphone of FIG. 2.

FIG. 4 is a cross-sectional view of the earphone of FIG. 1, taken along line IV-IV thereof.

FIG. 5 is a cross-sectional view of an earphone in accordance with a second embodiment of the present disclosure.

### DETAILED DESCRIPTION

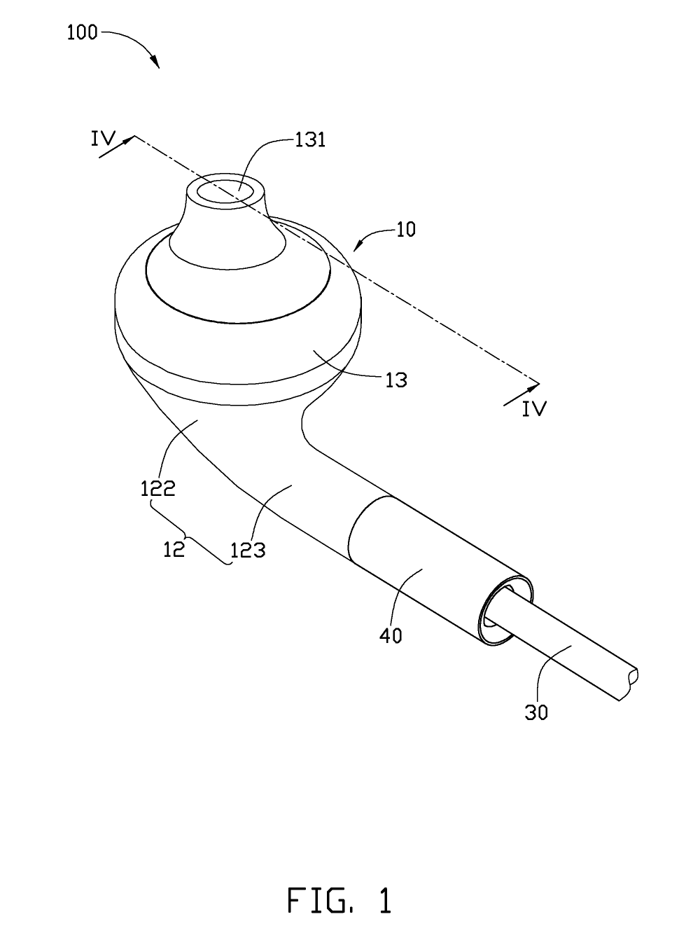

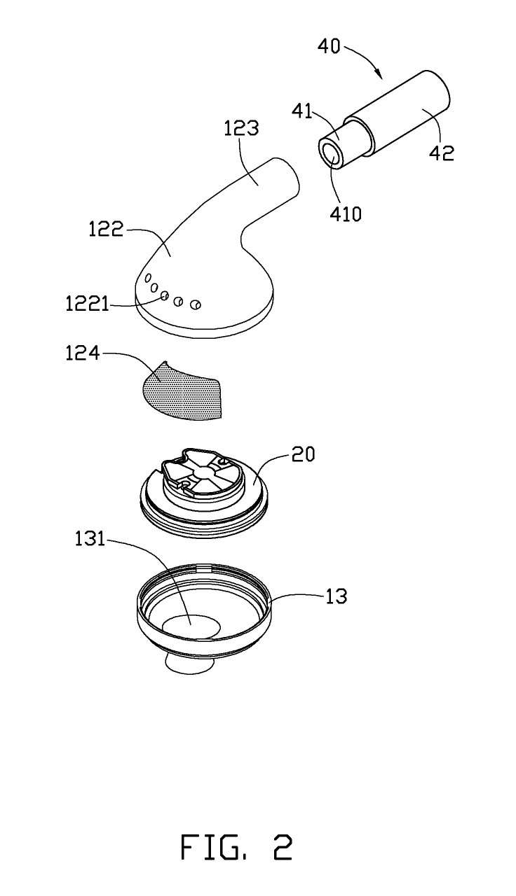

Referring to FIGS. 1-2, an earphone 100 according to a first embodiment of the present disclosure is shown. The earphone 100 includes a shell 10, a speaker 20 mounted in the shell 10, a wire 30 electrically connected with the speaker 20, and a sealing assembly 40 fixing the wire 30. In this embodiment, the wire 30 is an electrical cable covered with an insulating sheath.

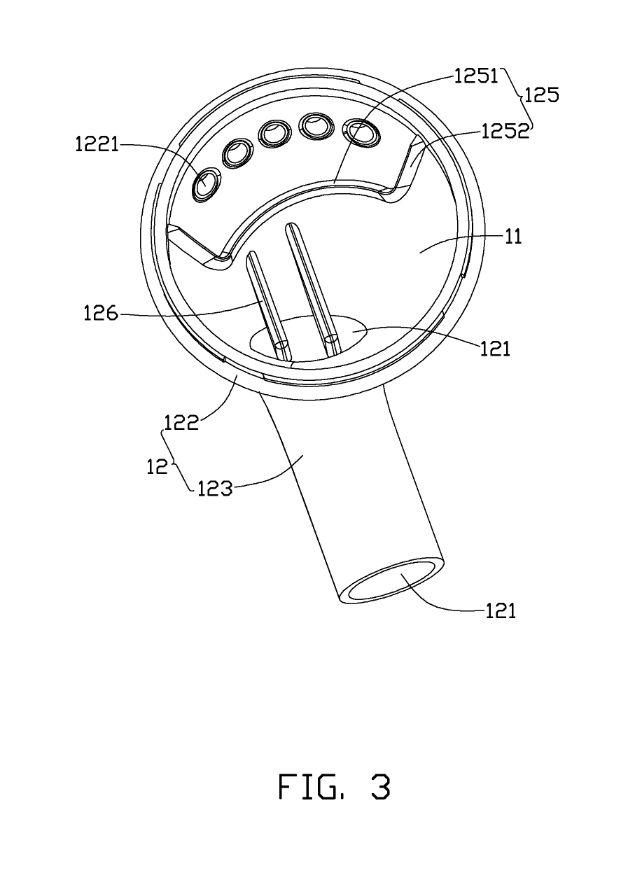

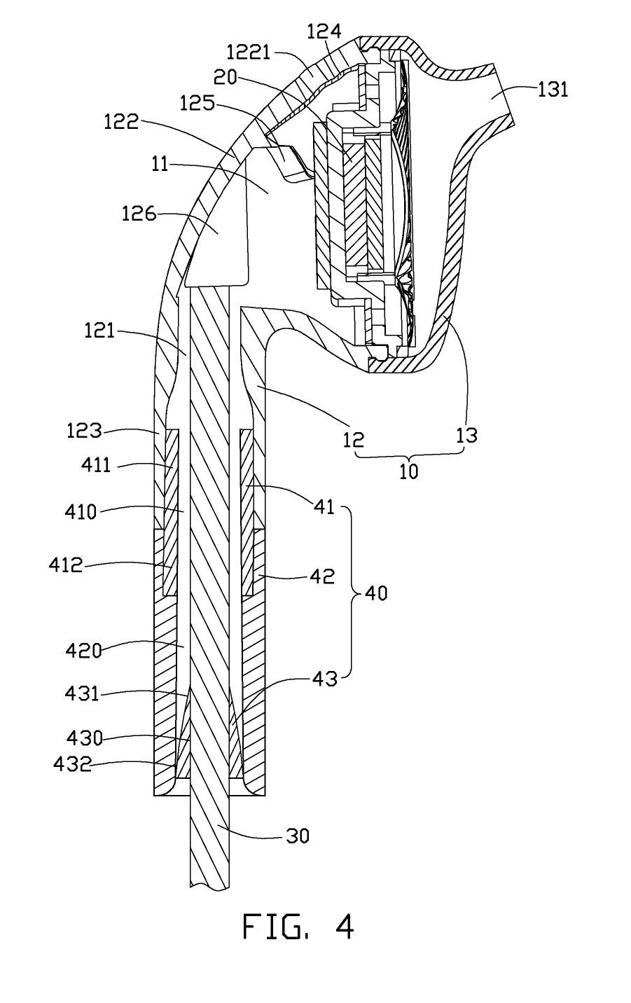

Referring also to FIGS. 3 and 4, the shell 10 is hollow and defines a sound cavity 11 therein. The speaker 20 is received in the sound cavity 11. The shell 10 includes a back cover 12, and a front cover 13 engaging with the back cover 12. The back cover 12 and the front cover 13 cooperatively define the sound cavity 11.

The back cover 12 defines a wire passage 121 therein. The wire passage 121 communicates with the sound cavity 11. The back cover 12 includes an expanding main body 122, and a tubular handle portion 123 extending from the main body 122. The wire passage 121 extends through the handle portion 123 longitudinally.

The main body 122 defines a plurality of sound pores 1221 therein, the sound pores 1221 communicating with the sound cavity 11. The sound pores 1221 are identical to each other, and are arranged in an imaginary arc line adjacent to an edge of the main body 122. A nonwoven piece 124 is attached on an inner wall of the main body 122 at a position defining the sound pores 1221. The nonwoven piece 124 is porous and covers the sound pores 1221, and is for adjusting a sound quality of the earphone 100 and protecting external contaminants from entering the sound cavity 11 of the earphone 100. A restricting flange 125 protrudes from the inner wall of the main body 122 toward the sound cavity 11. The restricting flange 125 surrounds the sound pores 1221, restricting a position of the nonwoven piece 124. The restricting flange 125 includes an arc portion 1251 and two straight portions 1252 at two opposite ends of the arc portion 1251. The arc portion 1251 is located between the sound pores 1221 and the wire passage 121. The two straight portions 1252 are located at two opposite sides of the sound pores 1221. Two positioning plates 126 protrude from the inner wall of the main body 122 adjacent to the wire passage 121. The two positioning plates 126 are parallel to each other. The wire 30 is positioned between the two positioning plates 126.

The front cover 13 is disc-shaped, and defines a sound leakage hole 131 facing the speaker 20 for releasing a sound of the speaker 20 to an outside of the earphone 100. The sound pores 1221 of the back cover 12 and the sound leakage hole 131 of the front cover 13 are respectively located at two opposite sides of the speaker 20, for adjusting an air pressure difference between the two opposite sides of the speaker 20.

Referring also to FIG. 4, the sealing assembly 40 includes a connecting sleeve 41 with one end mounted in the wire passage 121, a buffer sleeve 42 placed around another end of the connecting sleeve 41, and a sealing plug 43 mounted in the buffer sleeve 42.

The connecting sleeve 41 is made of hard plastic, metal, or other suitable material. The connecting sleeve 41 is tubular, and includes a head portion 411 and a tail portion 412. The head portion 411 and the tail portion 412 are aligned along an axis of the connecting sleeve 41, and together can be considered to comprise the entirety of the connecting sleeve 41. The head portion 411 is fixed in the wire passage 121. The tail portion 412 is located outside the wire passage 121, and the buffer sleeve 42 is placed around the tail portion 412 of the connecting sleeve 41. The connecting sleeve 41 defines a through hole 410 therein along the axis thereof. The through hole 410 communicates with the sound cavity 11 of the shell 10, for extending of the wire 30 therethrough.

The buffer sleeve 42 is made of resilient and sealable soft material such as rubber, silica gel, or other suitable soft material. The buffer sleeve 42 is tubular and defines a mounting hole 420 therein along an axis thereof. The mounting hole 420 of the buffer sleeve 42 communicates with the through hole 410 of the connecting sleeve 41, for extending of the wire 30 therethrough. Therefore bending of a portion of the wire 30 exposed outside the sealing assembly 40 can be gently restricted by the buffer sleeve 42. This decreases the risk of damage to or breakage of the wire 30 due to such bending.

The sealing plug 43 is made of resilient and sealable soft material such as rubber, silica gel, or other suitable soft material. The sealing plug 43 is mounted in the mounting hole 420 of the buffer sleeve 42. The sealing plug 43 is funneled, and includes a pointed end 431 and an obtuse end 432, which are at two opposite ends of an axial length of the sealing plug 43. That is, the sealing plug 43 is tapered from the obtuse end 432 to the pointed end 431. An outer diameter of the pointed end 431 is less than a diameter of the mounting hole 420 of the buffer sleeve 42. An outer diameter of the obtuse end 432 in a free state (without deformation) slightly exceeds the diameter of the mounting hole 420 of the buffer sleeve 42. The sealing plug 43 defines a fixing hole 430 therein along the axis thereof. The fixing hole 430 runs through the pointed end 431 and the obtuse end 432 of the sealing plug 43, for extending of the wire 30 therethrough. A diameter of the fixing hole 430 when the sealing plug 43 is in the free state does not exceed a diameter of the wire 30. In this embodiment, the diameter of the fixing hole 430 when the sealing plug 43 is in the free state is slightly less than that of the diameter of the wire 30.

In assembly of the earphone 100, firstly, the wire 30 is inserted through the fixing hole 430 of the sealing plug 43. During insertion of the wire 30, the sealing plug 43 resiliently swells slightly. Thus the wire 30 is fixed in the fixing hole 430 due to resilient contracting force applied by the sealing plug 43. The sealing plug 43 together with the wire 30 is inserted into the mounting hole 420 of the buffer sleeve 42, with the pointed end 431 entering the mounting hole 420 first. The obtuse end 432 of the sealing plug 43 is squeezed by an inner wall of the buffer sleeve 42, shrinking the sealing plug 43 to thereby further fix the wire 30 in the sealing plug 43. Furthermore, such shrinkage causes the sealing plug 30 to seal the mounting hole 420 of the buffer sleeve 42. The connecting sleeve 41, the buffer sleeve 42 and the sealing plug 43 cooperatively seal the wire passage 121, i.e., the sealing assembly 40 seals the wire passage 121.

In the earphone 100, the sound cavity 11 is relatively hermetic. Accordingly, sound generated by the speaker 20 resonates in the sound cavity 11, which improves a low frequency quality of the earphone 100. That is, the sound quality of the earphone 100 is conveniently improved. In addition, the sealing plug 43 seals the mounting hole 420 of the buffer sleeve 42, and inner spaces of the buffer sleeve 42 and the connecting sleeve 41 communicate with the sound cavity 11 of the shell 10, thereby expanding a volume of the sound cavity 11. Therefore, the low frequency quality of the earphone 100 can be further improved. Furthermore, external contaminants are prevented from entering the sound cavity 11 through the wire passage 121.

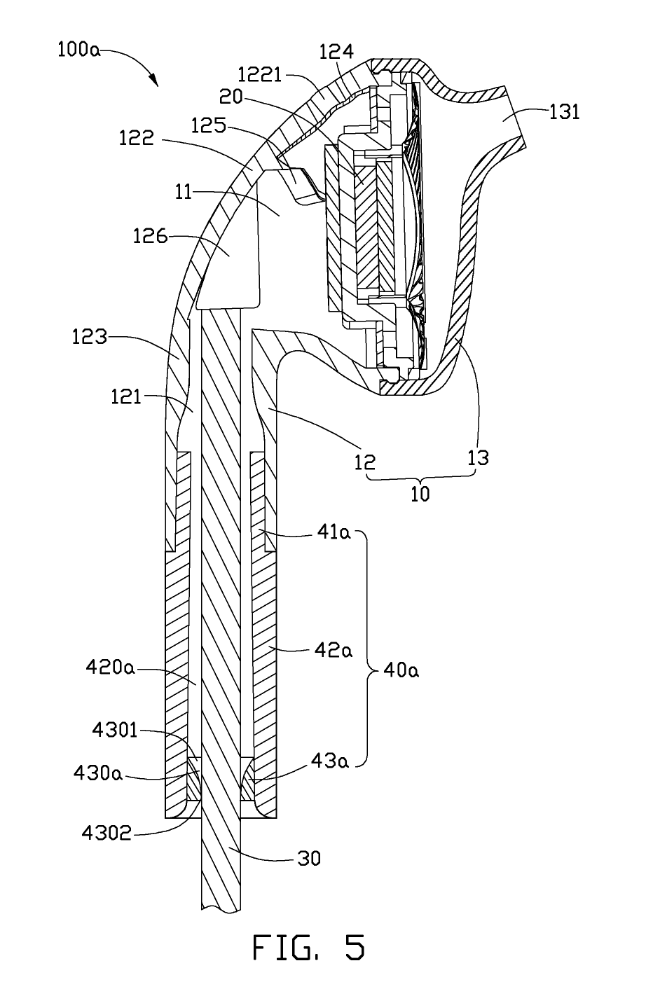

Referring to FIG. 5, an earphone 100a according to a second embodiment of the present disclosure is shown. The earphone 100a is similar to that of the previous embodiment. Differently, in the earphone 100a, a connecting sleeve 41a and a buffer sleeve 42a are integrally formed as one monolithic piece of the same material. The connecting sleeve 41a is fixed in the wire passage 121. The buffer sleeve 42a is located outside the wire passage 121. A mounting hole 420a runs through the connecting sleeve 41a and the buffer sleeve 42a longitudinally. The mounting hole 420a communicates with the sound cavity 11 through the wire passage 121 of the shell 10, for extending of the wire 30 therethrough. A sealing plug 43a is cylindrical, and made of resilient, sealable soft material, such as rubber, silica gel, or other suitable soft material. An outer diameter of the sealing plug 43a in a free state slightly exceeds a diameter of the mounting hole 420a. The sealing plug 43a defines a fixing hole 430a therein. The fixing hole 430a includes an amplifying opening 4301 and a contracting opening 4302 at two opposite ends thereof. The amplifying opening 4301 is open in a direction toward the mounting hole 420a. A diameter of the contracting opening 4302 in a free state is slightly less than that of the wire 30. A diameter of the fixing hole 430a increases gradually from the contracting opening 4302 to the amplifying opening 4301, facilitating insertion of the wire 30 into the fixing hole 430a and further expanding a volume of the sound cavity 11.

In assembly of the earphone 100a, firstly, the wire 30 is inserted in the fixing hole 430a of the sealing plug 43a. During insertion of the wire 30, the sealing plug 43a resiliently swells slightly. The wire 30 is fixed in the fixing hole 430a due to resilient contracting force applied by the sealing plug 43a. The sealing plug 43a together with the wire 30 is inserted in the mounting hole 420a. The sealing plug 43a is squeezed by an inner wall of the buffer sleeve 42a to shrink and thereby further fix the wire 30 in the sealing plug 43a. Furthermore, the sealing plug 43a seals the mounting hole 420a. The connecting sleeve 41a, the buffer sleeve 42a and the sealing plug 43a cooperatively seal the wire passage 121, i.e., the sealing assembly 40a seals the wire passage 121.

In the second embodiment, the sealing plug 43a and the buffer sleeve 42a are separately produced. Nevertheless, in other embodiments, the sealing plug 43a and the buffer sleeve 42a can be integrally formed as one monolithic piece of the same material. Such material can be a resilient, sealable soft material, such as rubber, silica gel, or other suitable soft material. In still other embodiments, the sealing plug 43a and the buffer sleeve 42a can be made of different materials, but with the sealing plug 43a being integrally formed on the inner wall of the buffer sleeve 42a insofar as the sealing plug 43a is bonded on the inner wall of the buffer sleeve 42a.

It is to be understood, however, that even though numerous characteristics and advantages of the exemplary embodiments have been set forth in the foregoing description, together with details of the structures and functions of the embodiments, the disclosure is illustrative only, and that changes may be made in detail, especially in matters of shape, size, and arrangement of parts within the principles of the embodiments to the full extent indicated by the broad general meaning of the terms in which the appended claims are expressed.

What is claimed is:

1. An earphone comprising:
a shell defining a sound cavity and a wire passage therein, the sound cavity and the wire passage communicating with each other;
a speaker mounted in the sound cavity;
a wire extending through the wire passage to the sound cavity and electrically connecting with the speaker; and
a sealing assembly coupled with the shell, the sealing assembly sealing the wire passage from the outside environment.

2. The earphone of claim 1, wherein the sealing assembly comprises a sealing plug and a buffer sleeve surrounding a circumference of the sealing plug, the buffer sleeve defines a mounting hole therein, the mounting hole communicates with the wire passage, the sealing plug is made of resilient and sealable material and defines a fixing hole therein, the wire is fixed in the fixing hole, and the sealing plug in cooperation with the wire seals the mounting hole of the buffer sleeve.

3. The earphone of claim 2, wherein the sealing plug is mounted in the mounting hole of the buffer sleeve, the sealing assembly further comprises a connecting sleeve, the connecting sleeve defines a through hole therein, the through hole communicates with the wire passage for extending of the wire therethrough, one end of the connecting sleeve is fixed in the wire passage, and the buffer sleeve is attached around an opposite end of the connecting sleeve.

4. The earphone of claim 2, wherein the sealing plug is mounted in the mounting hole of the buffer sleeve, the sealing assembly further comprises a connecting sleeve, the connecting sleeve and the buffer sleeve are integrally formed as one monolithic piece of the same material, the connecting sleeve is fixed in the wire passage, and the mounting hole extends through the buffer sleeve and the connecting sleeve for extending of the wire therethrough.

5. The earphone of claim 2, wherein the sealing plug is mounted in the mounting hole of the buffer sleeve, the sealing plug comprises a pointed end and a obtuse end at two opposite ends thereof, an outer diameter of the sealing plug decreases gradually from the obtuse end to the pointed end, the pointed end faces the mounting hole of the buffer sleeve, an outer diameter of the pointed end is less than a diameter of the mounting hole, and an outer diameter of the obtuse end in a free state slightly exceeds the diameter of the mounting hole.

6. The earphone of claim 2, wherein the fixing hole comprises an amplifying opening and a contracting opening at two opposite ends thereof, a diameter of the fixing hole decreases from the amplifying opening to the contracting opening, the amplifying opening is open in a direction toward the mounting hole of the buffer sleeve, and a diameter of the contracting opening is slightly less than a diameter of the wire.

7. The earphone of claim 6, wherein the sealing plug is cylindrical and is mounted in the mounting hole of the buffer sleeve, and an outer diameter of the sealing plug in a free state slightly exceeds a diameter of the mounting hole of the buffer sleeve.

8. The earphone of claim 6, wherein the sealing plug and the buffer sleeve are integrally formed as one monolithic piece of the same material, and such material is a resilient and sealable material.

9. The earphone of claim 6, wherein the sealing plug and the buffer sleeve are made of different materials, but with the sealing plug being integrally formed on an inner wall of the buffer sleeve insofar as the sealing plug is bonded to the inner wall.

10. The earphone of claim 1, further comprising a porous nonwoven piece, wherein the shell defines a plurality of sound pores communicating with the sound cavity, the nonwoven piece is attached on an inner wall of the shell, and the nonwoven piece covers the sound pores.

11. The earphone of claim 10, wherein a restricting flange is formed on the inner wall of the shell for restricting a position of the nonwoven piece.

12. The earphone of claim 1, wherein the shell comprises a front cover and a back cover engaging with the front cover, the front cover and the back cover cooperatively define the sound cavity, the back cover defines a plurality of sound pores, the front cover defines a sound leakage hole therein, and the sound pores and the sound leakage hole are respectively located at two opposite sides of the speaker.

13. An earphone comprising:
a shell defining a sound cavity and a wire passage therein, the sound cavity and the wire passage communicating with each other;
a speaker mounted in the sound cavity;
a wire extending through the wire passage to the sound cavity and electrically connecting with the speaker; and
a sealing assembly coupled with the shell, the sealing assembly comprising a buffer sleeve and a sealing plug mounted in the buffer sleeve, the buffer sleeve defining a mounting hole therein, the mounting hole communicating with the wire passage, the sealing plug mounted in the mounting hole, the sealing plug defining a fixing hole therein for extending of the wire therethrough, the sealing plug resiliently squeezing the wire and sealing the mounting hole, the buffer sleeve, the sealing plug and the wire cooperatively sealing the wire passage from the outside environment.

14. The earphone of claim 13, wherein the sealing assembly further comprises a connecting sleeve, the connecting sleeve defines a through hole therein, the through hole communicates with the wire passage for extending of the wire therethrough, one end of the connecting sleeve is fixed in the wire passage, and the buffer sleeve is attached around an opposite end of the connecting sleeve.

15. The earphone of claim 13, wherein the sealing assembly further comprises a connecting sleeve, the connecting sleeve and the buffer sleeve are integrally formed as one monolithic piece of the same material, the connecting sleeve is fixed in the wire passage, and the mounting hole extends through the buffer sleeve and the connecting sleeve for extending of the wire therethrough.

16. The earphone of claim 13, wherein the sealing plug comprises a pointed end and a obtuse end at two opposite ends thereof, an outer diameter of the sealing plug decreases gradually from the obtuse end to the pointed end, the pointed end faces the mounting hole of the buffer sleeve, an outer diameter of the pointed end is less than a diameter of the mounting hole, and an outer diameter of the obtuse end in a free state slightly exceeds the diameter of the mounting hole.

17. The earphone of claim 13, wherein the fixing hole comprises an amplifying opening and a contracting opening at two opposite ends thereof, a diameter of the fixing hole decreases from the amplifying opening to the contracting opening, the amplifying opening is open in a direction toward the mounting hole of the buffer sleeve, and a diameter of the contracting opening is slightly less than a diameter of the wire.

18. The earphone of claim 17, wherein the sealing plug is cylindrical, and an outer diameter of the sealing plug in a free state slightly exceeds a diameter of the mounting hole of the buffer sleeve.
